(19) United States
(12) Patent Application Publication
(10) Pub. No.: US 2022/0180220 A1
(43) Pub. Date: Jun. 9, 2022

(54) INFERENCE DEVICE, INFERENCE METHOD, AND RECORDING MEDIUM

(71) Applicants: NEC CORPORATION, Tokyo (JP); NATIONAL INSTITUTE OF ADVANCED INDUSTRIAL SCIENCE AND TECHNOLOGY, Tokyo (JP)

(72) Inventors: Shumpei KUBOSAWA, Tokyo (JP); Takashi ONISHI, Tokyo (JP); Yoshimasa TSURUOKA, Tokyo (JP)

(73) Assignees: NEC CORPORATION, Tokyo (JP); NATIONAL INSTITUTE OF ADVANCED INDUSTRIAL SCIENCE AND TECHNOLOGY, Tokyo (JP)

(21) Appl. No.: 17/442,380

(22) PCT Filed: Mar. 16, 2020
(86) PCT No.: PCT/JP2020/011474

§ 371 Date: Sep. 23, 2021

(30) Foreign Application Priority Data
Mar. 28, 2019 (JP) 2019-064976

(51) Int. Cl. G06N 5/02

(52) U.S. Cl. CPC G06N 5/027

(57) ABSTRACT

An inference device performs a qualitative inference using an inference rule which, from an input of a value indicating an increase and a value indicating a decrease, derives an output representing any one of an increase, a decrease, or no change.

### TECHNICAL FIELD

The present invention relates to an inference device, an inference method, and a recording medium.

### BACKGROUND ART

Several techniques have been proposed in connection with qualitative inference.

For example, Patent Document 1 describes a service design support device that, when a qualitative simulation is performed at the design state of an IT service, enables the output result to be interpreted in association with an actual service behavior. The service design support device determines a combination of parameters in the service design information that may affect the quality of a target service based on the connection state of a system component device serving as an execution base of the target service. Then, the service design support device determines whether or not a list of service behaviors (state transitions) in the simulation result contains a transition to a state which is interpreted as a loss of service quality.

### PRIOR ART DOCUMENTS

### [Patent Document]

[Patent Document 1] Japanese Unexamined Patent Application, First Publication No. 2018-142032

### SUMMARY OF THE INVENTION

### Problem to be Solved by the Invention

Suppose that an inference using a qualitative inference is performed with respect to a target having a configuration that produces a single output from a plurality of inputs (such as the relationship between the inlet side flow rate, the valve opening degree, and the outlet side flow rate when a flow rate adjustment valve is the target), and planning is performed to control the target according to the inference result. In this case, it may not be possible to uniquely determine the increase or decrease in an output amount because the increases and decreases in the plurality of input amounts of the target may conflict with each other. On the other hand, it is preferable to be able to present a possible plan by such planning.

An example object of the present invention is to provide an inference device, an inference method, and a recording medium that are capable of solving the above problem.

### Means for Solving the Problem

According to a first example aspect of the present invention, an inference device includes: an inference means for performing a qualitative inference using an inference rule which, from an input of a value indicating an increase and a value indicating a decrease, derives an output representing any one of an increase, a decrease, or no change.

According to a second example aspect of the present invention, an inference method includes: performing a qualitative inference using an inference rule which, from an input of a value indicating an increase and a value indicating a decrease, derives an output representing any one of an increase, a decrease, or no change.

According to a third example aspect of the present invention, a recording medium stores a program for causing a computer to execute: performing a qualitative inference using an inference rule which, from an input of a value indicating an increase and a value indicating a decrease, derives an output representing any one of an increase, a decrease, or no change.

### Effect of the Invention

According to an example embodiment of the present invention, a possible plan can be presented in control planning that uses a qualitative inference.

### BRIEF DESCRIPTION OF THE DRAWINGS

FIG. 1 is a schematic block diagram showing a functional configuration of an inference device according to an example embodiment.

FIG. 2 is a diagram showing an example of an inference target of the inference device according to the example embodiment.

FIG. 3 is a diagram showing an example of a configuration of the inference device according to the example embodiment.

FIG. 4 is a diagram showing an example of the processing procedure of an inference method according to the example embodiment.

FIG. 5 is a schematic block diagram showing a configuration of a computer according to at least one example embodiment.

### EXAMPLE EMBODIMENT

Hereunder, example embodiments of the present embodiment will be described. However, the following example embodiments do not limit the invention according to the claims. Furthermore, all combinations of features described in the example embodiments may not be essential to the solution means of the invention.

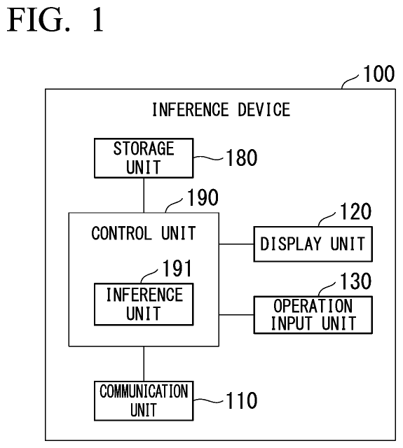

FIG. 1 is a schematic block diagram showing a functional configuration of an inference device 100 according to the example embodiment. In the configuration shown in FIG. 1, the inference device 100 includes a communication unit 110, a display unit 120, an operation input unit 130, a storage unit 180, and a control unit 190. The control unit 190 includes an inference unit 191.

The inference device 100 performs a qualitative inference. In particular, the inference device 100 performs a qualitative inference by switching inference rules between behavior estimation, which does not involve direct control of a control target, and planning for controlling a control target (hereunder referred to as control planning). As a result, the inference device 100 is capable of presenting a possible plan.

The control target (the target of the inference performed by the inference device 100) may be, for example, a chemical plant that produces a synthetic product from a plurality of raw materials. For example, in a chemical plant, which is the control target, a synthetic product is produced from a plurality of raw materials via a plurality of intermediates. In such a chemical plant, synthetic products or intermediates are produced through multiple processes, from an input to each process. In such a chemical plant, an adjustment valve for adjusting the input amount to the process, an adjustment valve for adjusting the output amount from the process, and the like are installed with respect to each process.

In the present example embodiment, for convenience of description, it is assumed that the control target is a chemical plant. Furthermore, in order to produce the desired synthetic product, the degree by which each flow rate adjustment valve installed in the chemical plant is opened or closed (opening degree) is controlled. In this case, the inference device 100 uses a qualitative inference to estimate, for example, the state of each flow rate adjustment valve (for example, an increase or decrease in the valve opening degree) when producing the desired synthetic product. The degree by which each flow rate adjustment valve is opened or closed is controlled according to the estimated state (inference result).

However, the control target (the target of the inference performed by the inference device 100) is not limited to a chemical plant, and may be any target that includes a process in which an output amount is determined according to an input amount. The control target may be, for example, a factory that produces electrical products, a factory that produces processed agricultural products, and the like.

The communication unit 110 performs communication with other devices. For example, the communication unit 110 acquires information used in a qualitative inference, such as information relating to inference rules and propositions, from other devices.

The display unit 120 includes, for example, a display screen such as a liquid crystal panel or an LED (Light Emitting Diode) panel, and displays various images. For example, the display unit 120 displays the inference result obtained by the inference device 100.

The operation input unit 130 includes input devices such as a keyboard and a mouse, and accepts user operations. For example, when the user inputs information used in a qualitative inference, the operation input unit 130 accepts the input.

The storage unit 180 stores various information. The storage unit 180 is configured by using a storage device included in the inference device 100.

The storage unit 180 stores, for example, an inference rule that represents the state of each component of the control target, and an inference rule that represents the correspondence between the input of each component and the output of the component. When the components are the flow rate adjustment valves installed with respect to each material in a process that produces a single mixture from two materials, the storage unit 180 may store information in advance that represents an inference rule which indicates that the output amount increases when both of the two input amounts increase. Similarly, the storage unit 180 may store information in advance that represents an inference rule which indicates that the output amount decreases when both of the two input amounts decrease. Furthermore, the storage unit 180 may store information in advance that represents an inference rule which indicates that there is no change in the output amount when there is no change in both of the two input amounts. The storage unit 180 may store inference rules created as described later.

However, the inference rules used by the inference device 100 are not limited to the examples described above.

The control unit 190 executes various processing by controlling each unit of the inference device 100. The functions of the control unit 190 are executed as a result of a CPU (Central Processing Unit) included in the inference device 100 reading a program from the storage unit 180 and executing it.

The inference unit 191 executes the qualitative inference of the inference device 100. In particular, in the case of control planning, the inference unit 191 performs a qualitative inference using an inference rule which, from an input of a value indicating an increase and a value indicating a decrease, derives an output representing any of an increase, a decrease, or no change (an output indicating an increase, a decrease, or no change). For example, in the example of the chemical plant, if a single mixture is produced by mixing two materials, the input represents the state (such as an increase or decrease in the opening degree) of the flow rate adjustment valves installed for adjusting the amount of the two materials. Furthermore, the output represents an increase or decrease in the amount of the mixture.

Moreover, in the case of control planning and the case of behavior estimation, the inference unit 191 performs a qualitative inference by switching between using an inference rule that derives one of an increase, a decrease, or no change (an inference rule for control planning), and an inference rule that derives an indefinite value (an inference rule for behavior control).

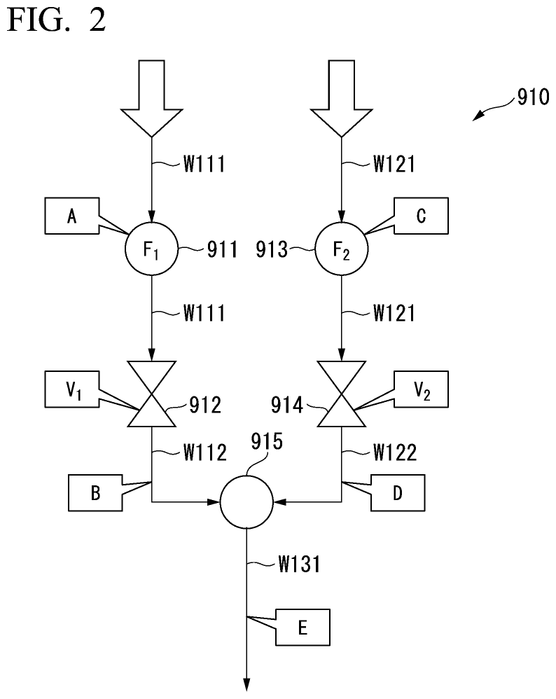

FIG. 2 is a diagram showing an example of an inference target of the inference device 100. FIG. 2 shows an example in which the inference device 100 infers an increase or decrease in the flow rate of a fluid in a piping provided with flow rate adjustment valves.

In the piping 910 shown in FIG. 2, the fluid flowing through the flow path W111 inside the piping flows into the flow rate adjustment valve 912. After passing through the flow rate adjustment valve 912, the fluid flows through the flow path W112. A flow meter 911 is provided in the flow path W111. Furthermore, the fluid flowing through the flow path W121 flows into the flow rate adjustment valve 914. After passing through the flow rate adjustment valve 914, the fluid flows through the flow path W122. A flow meter 913 is provided in the flow path W121.

The fluid flowing through the flow path W112 and the fluid flowing through the flow path W122 merge at a joined position 915 of the piping, and the merged fluid flows through the flow path W131.

The flow paths W111, W112, W121, W122, and W131 are referred to as “A”, “B”, “C”, “D”, and “E”, respectively. Moreover, the flow meters 911 and 913 are referred to as “F₁” and “F₂”, respectively. The flow rate adjustment valves 912 and 914 are referred to as “v₁” and “v₂”, respectively.

The inference device 100 does not perform a quantitative inference such that how much the flow rate is, but performs a qualitative inference as to whether an increase, a decrease, or no change (no increase or decrease) occurs in the flow rate.

An increase, a decrease, and no change in the flow rate are indicated by “+”, “−”, and “0”, respectively. An increase, a decrease, and no change in the opening degree of a flow rate adjustment valve are also indicated by “+”, “−”, and “0”, respectively.

The increase or decrease in the flow rate of the fluid in the flow path W112 is affected by an increase or decrease in the flow rate of the fluid in the flow path W111, and an increase or decrease in the opening degree of the flow rate adjustment valve 912. This is expressed as “B=bin(A, v₁)”. Here, bin indicates a binary operator.

The increase or decrease in the flow rate of the fluid in the flow path W122 is affected by an increase or decrease in the flow rate of the fluid in the flow path W121, and an increase or decrease in the opening degree of the flow rate adjustment valve 914. This is expressed as “D=bin(C, v₂)”.

The increase or decrease in the flow rate of the fluid in the flow path W131 is affected by an increase or decrease in the flow rate of the fluid in the flow path W112, and an increase or decrease in the flow rate of the fluid in the flow path W122. This is expressed as “E=bin(B, D)”.

The value of bin is set as follows.

First, bin(0,0) is defined as in equation (1).

$$[ Equation 1 ]$$

$$bin ( 0 , 0 ) = 0 \qquad ( 1 )$$

Equation (1) indicates that if both of the bin arguments (influencing values) represent no change (no increase or decrease), the bin value (influenced value) also represents no change (no increase or decrease). For example, if there is no change in the flow rate of the fluid in the flow path W111, and there is no change in the opening degree of the flow rate adjustment valve 912, then the inference unit 191 infers based on “B=bin(A, v₁)” that there is no change in the flow rate of the fluid in the flow path W112.

Furthermore, as shown in equation (2), if at least one of the bin arguments (affecting values) indicates an increase (“+”), and the value of the other argument indicates an increase (“+”) or no change (“0”), the bin value (influenced value) also indicates an increase (“+”).

$$[ Equation 2 ]$$

$$bin ( 0 , + ) = bin ( + , 0 ) = bin ( + , + ) = + \qquad ( 2 )$$

For example, if the flow rate of the fluid in the flow path W111 has increased, and there is no change in the opening degree of the flow rate adjustment valve 912, the inference unit 191 infers based on “B=bin(A, v₁)” that the flow rate of the fluid in the flow path W112 has increased.

Moreover, as shown in equation (3), if at least one of the bin arguments (influencing values) indicates a decrease (“−”), and the value of the other argument indicates a decrease (“−”) or no change (“0”), the bin value (affected value) also indicates a decrease (“−”).

$$[ Equation 3 ]$$

$$bin ( 0 , - ) = bin ( - , 0 ) = bin ( - , - ) = - \qquad ( 3 )$$

For example, if the flow rate of the fluid in the flow path W111 has decreased, and there is no change in the opening degree of the flow rate adjustment valve 912, the inference unit 191 infers based on “B=bin(A, v₁)” that the flow rate of the fluid in the flow path W112 has decreased.

On the other hand, if one of the bin arguments (influencing values) indicates an increase (“+”), and the other indicates a decrease (“−”), the bin value (influenced value) may indicate any one of an increase (“+”), a decrease (“−”), or no change (“0”). This is shown in equation (4).

$$[ Equation 4 ]$$

$$bin ( - , + ) = bin ( + , - ) = ? \qquad ( 4 )$$

Here, “?” indicates that the value cannot be uniquely determined.

For example, if the flow rate of the fluid in the flow path W111 has decreased, and the opening degree of the flow rate adjustment valve 912 has increased, then in order to determine the increase or decrease in the flow rate of the fluid in the flow path W112, quantitative information such as the amount of decrease in the flow rate of the fluid in the flow path W111 and the amount of increase in the opening degree of the flow rate adjustment valve 912 is required. Therefore, a qualitative inference cannot uniquely estimate the increase or decrease in the flow rate of the fluid in the flow path W112.

Consequently, the inference unit 191 infers that the flow rate of the fluid in the flow path W112 cannot be specified (“?”) based on “B=bin (A, v₁)”.

Furthermore, if the value of any of the bin arguments (influencing values) cannot be uniquely determined (“?”), the bin value also cannot be uniquely determined (becomes “?”). This is shown in equation (5).

$$[ Equation 5 ]$$

$$bin (* , ? ) = bin ( ? , *) = ? \qquad ( 5 )$$

Here, “*” is a wildcard, and represents “+”, “−”, or “0”.

For example, when the flow rate of the fluid in the flow path W112 cannot be specified (“?”), the inference unit 191 infers that the flow rate in the flow path W131 cannot be specified (“?”) based on “E=bin(B, D)”.

As described above, in the case of behavior estimation such as estimation of an increase or decrease in the flow rate, the value of the inference result may not be uniquely determined depending on the state on which the inference is premised.

On the other hand, in the case of control planning such as setting the opening degree of a flow rate adjustment valve, it is effective to show a possible plan even when it is not certain that the desired result can be obtained.

For example, if the flow rate of the fluid in the flow path W111 in FIG. 2 has increased, but the flow rate of the fluid in the flow path W112 is desired to be kept constant (desired to be not increased or decreased), it is effective to reduce the opening degree of the flow rate adjustment valve 912.

The amount by which the opening degree of the flow rate adjustment valve 912 is reduced cannot be obtained by a qualitative inference because it needs to be obtained by a quantitative inference. However, if it can be inferred that the opening degree of the flow rate adjustment valve 912 should be reduced, it is considered effective for this to be presented.

Therefore, the inference unit 191 performs an inference using different inference rules for diagnosis (behavior estimation) and control planning.

For example, in behavior estimation that infers the increase or decrease in the flow rate of the fluid in the flow path W112 based on an increase or decrease in the flow rate of the fluid in the flow path W111, and an increase or decrease in the opening degree of a flow rate adjustment valve, the inference unit 191 performs the inference using the inference rule shown in equation (4) above.

In contrast, in control planning of the opening degree of the flow rate adjustment valve 912, which is performed so that the increase or decrease in the flow rate of the fluid in the flow path W112 becomes a desired state in response to an increase or decrease in the flow rate of the fluid in the flow path W111, the inference unit 191 performs the inference using the inference rule shown in equation (6) instead of equation (4).

$$[ Equation 6 ]$$

$$cbin ( - , + ) = cbin ( + , - ) = 0 \qquad ( 6 )$$

Here, “cbin” is a binary operation that replaces “bin” in equation (4). Like the case of “bin”, it represents the relationship between an increase or decrease in the arguments of “cbin” and an increase or decrease in the value of “cbin”. The difference between equation (4) and equation (6) is whether the value on the right side is “?” or “0”.

As a result, the inference unit 191 is capable of calculating and presenting a plan that displays an increase or decrease in the opening degree of the flow rate adjustment valve 912 in order to bring the increase or decrease in the flow rate in the flow path W112 to a desired state.

Here, the difference between behavior estimation and control planning is whether or not the inference result is directly used to control an object. For example, in behavior estimation such as estimation of an increase or decrease in the flow rate, even if it is inferred that the flow rate increases, a control that increases the flow rate according to the inference result is not performed. On the other hand, in control planning such as setting the opening degree of a flow rate adjustment valve, the opening degree of the flow rate adjustment valve can be decreased according to an inference result indicating that the opening degree of the flow rate adjustment valve is decreased.

Equation (6) can be described as inference rules like equations (7) and (8). When the flow rate on the inlet side of a flow rate adjustment valve decreases, such as when the flow rate of the fluid in the flow path W111 decreases, the inference rule in equation (7) can be used.

$$[ Equation 7 ]$$

$$decrease ( x ) ⩓ increase ( v ) ⇒ unchange ( z ) ⩓ cbin ( x , v , z ) \qquad ( 7 )$$

Here, “decrease” represents a predicate indicating a decrease in a quantity. For example, “decrease(x)” represents “a decrease in x”. Further, “increase” indicates an increase in a quantity. For example, “increase(v)” represents “an increase in v”. Also, “unchange” represents a predicate indicating no increase or decrease in a quantity. For example, “unchange(z)” represents “no increase or decrease (no change) in z”. Further, “cbin” represents a predicate that indicates that the arguments x, v, and z have the relationship of being arguments (x and v) of the binary operation “cbin” in equation (6) and the value (z) of “cbin”. The symbol “=>” represents “then” (that is to say, an implication). The symbol “\hat{ }” represents the logical product.

On the other hand, when the flow rate on the inlet side of a flow rate adjustment valve increases, such as when the flow rate of the fluid in the flow path W111 increases, the inference rule in equation (8) can be used.

$$[ Equation 8 ]$$

$$increase ( x ) ⩓ decrease ( v ) ⇒ unchange ( z ) ⩓ cbin ( x , v , z ) \qquad ( 8 )$$

The inference unit 191 may automatically decide between using an inference rule for behavior estimation and an inference rule for control planning, according to the application target of the inference rule.

For example, the inference unit 191 may automatically decide between using an inference rule for behavior estimation and an inference rule for control planning based on a metarule, such that an inference rule based on equation (4) is used when performing a deductive inference, and an inference rule based on equation (6) is used when performing an abductive inference.

Alternatively, the inference device 100 may decide between using an inference rule for behavior estimation and an inference rule for control planning by having the user of the inference device 100 perform a user operation using the operation input unit 130 that instructs a switch between a behavior estimation mode and a control planning mode.

As described above, the inference unit 191 performs a qualitative inference using an inference rule (inference rule for control planning) which, from an input of a value indicating an increase and a value indicating a decrease, derives an output representing any of an increase, a decrease, or no change.

As a result, in the inference device 100, a possible plan can be presented in control planning that uses a qualitative inference.

Here, the inference rule used for deduction may not enable a value to be uniquely determined as in equation (4) above. Specifically, when performing a qualitative inference of an increase or decrease, such as an increase, a decrease, or no change in the flow rate of a fluid, the increase or decrease can sometimes only be determined after performing a quantitative calculation. In this case, the value is not uniquely determined by a qualitative inference.

When such an inference rule is used to perform control planning such as increasing or decreasing the opening degree of a flow rate adjustment valve, the appearance of a “?” (an item for which the value cannot be uniquely determined) in the inference rule can sometimes cause the inference rule to not be appropriately selected, and the control planning may not be appropriately performed.

In contrast, in the inference device 100, a qualitative inference is performed by using an inference rule which, from an input of a value indicating an increase and a value indicating a decrease, derives an output representing any of an increase, a decrease, or no change. Therefore, a possible plan can be proposed.

For example, if the flow rate of the fluid in the flow path W111 in FIG. 2 has increased, but the flow rate of the fluid in the flow path W112 is desired to be kept constant (desired to be not increased or decreased), as a result of the inference unit 191 performing a hypothetical inference using an inference rule based on equation (6) instead of equation (4), a reduction in the opening degree of the flow rate adjustment valve 912 can be proposed.

Moreover, the inference unit 191 performs qualitative inference by switching between using an inference rule that derives one of an increase, a decrease, or no change (an inference rule for control planning), and an inference rule that derives an indefinite value (an inference rule for behavior estimation).

As a result, the inference device 100 is capable of performing both behavior estimation and control planning with a high accuracy.

For example, when the flow rate of the fluid in the flow path W111 in FIG. 2 has increased, and the opening degree of the flow rate adjustment valve 912 has decreased, if the increase or decrease in the flow rate of the fluid in the flow path W112 is inferred by deduction using an inference rule based on equation (6), the estimation result of the flow rate of the fluid in the flow path W112, which should be “?” (the value cannot be uniquely determined), becomes “0”. Therefore, the inference accuracy becomes low.

On the other hand, as a result of the inference unit 191 deciding between using an inference rule for behavior estimation and an inference rule for control planning, it is possible to avoid such a decrease in the inference accuracy.

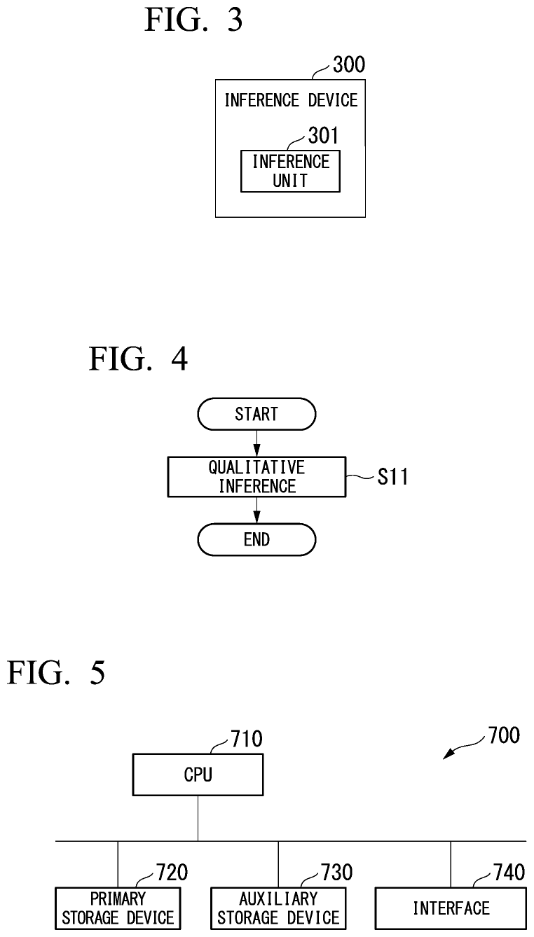

FIG. 3 is a diagram showing an example of a configuration of an inference device 300 according to the example embodiment.

In the example shown in FIG. 3, the inference device 300 includes an inference unit 301.

In this configuration, the inference unit 301 performs a qualitative inference using an inference rule which, from an input of a value indicating an increase and a value indicating a decrease, derives an output representing any of an increase, a decrease, or no change.

As a result, according to the inference device 300, a possible plan can be presented in control planning that uses a qualitative inference.

Here, the inference rule used for deduction may not enable a value to be uniquely determined as in equation (4) above. Specifically, when performing a qualitative inference of an increase or decrease, such as an increase, a decrease, or no change in the flow rate of a fluid, the increase or decrease can sometimes only be determined after performing a quantitative calculation. In this case, the value is not uniquely determined by a qualitative inference.

When such an inference rule is used to perform control planning such as increasing or decreasing the opening degree of a flow rate adjustment valve, the appearance of a “?” (an item for which the value cannot be uniquely determined) in the inference rule can sometimes cause the inference rule to not be appropriately selected, and the control planning may not be appropriately performed.

In contrast, in the inference device 300, a qualitative inference is performed by using an inference rule which, from an input of a value indicating an increase and a value indicating a decrease, derives a value representing any of an increase, a decrease, or no change. Therefore, a possible plan can be proposed.

For example, if the flow rate of the fluid in the flow path W111 in FIG. 2 has increased, but the flow rate of the fluid in the flow path W112 is desired to be kept constant (desired to be not increased or decreased), as a result of the inference unit 301 performing a hypothetical inference using an inference rule based on equation (6) instead of equation (4), a reduction in the opening degree of the flow rate adjustment valve 912 can be proposed.

FIG. 4 is a diagram showing an example of the processing procedure of an inference method according to the example embodiment.

The inference method shown in FIG. 4 includes a step of performing a qualitative inference (step S11).

In step S11, a qualitative inference is performed using an inference rule which, from an input of a value indicating an increase and a value indicating a decrease, derives an output representing any of an increase, a decrease, or no change.

As a result, in the inference method shown in FIG. 4, a possible plan can be presented in control planning that uses a qualitative inference.

Here, the inference rule used for deduction may not enable a value to be uniquely determined as in equation (4) above. Specifically, when performing a qualitative inference of an increase or decrease, such as an increase, a decrease, or no change in the flow rate of a fluid, the increase or decrease can sometimes only be determined after performing a quantitative calculation. In this case, the value is not uniquely determined by a qualitative inference.

When such an inference rule is used to perform control planning such as increasing or decreasing the opening degree of a flow rate adjustment valve, the appearance of a “?” (an item for which the value cannot be uniquely determined) in the inference rule can sometimes cause the inference rule to not be appropriately selected, and the control planning may not be appropriately performed.

In contrast, in the inference method shown in FIG. 4, a qualitative inference is performed by using an inference rule which, from an input of a value indicating an increase and a value indicating a decrease, derives an output representing any of an increase, a decrease, or no change. Therefore, a possible plan can be proposed.

For example, if the flow rate of the fluid in the flow path W111 in FIG. 2 has increased, but the flow rate of the fluid in the flow path W112 is desired to be kept constant (desired to be not increased or decreased), by performing a hypothetical inference using an inference rule based on equation (6) instead of equation (4), a reduction in the opening degree of the flow rate adjustment valve 912 can be proposed.

FIG. 5 is a schematic block diagram showing a configuration of a computer according to at least one example embodiment.

In the configuration shown in FIG. 5, the computer 700 includes a CPU (Central Processing Unit) 710, a primary storage device 720, an auxiliary storage device 730, and an interface 740.

Any one or more of the inference devices 100 and 300 described above may be implemented by the computer 700. In this case, the operation of each of the processing units described above is stored in the auxiliary storage device 730 in the form of a program. The CPU 710 reads the program from the auxiliary storage device 730, expands the program in the main storage device 720, and executes the processing described above according to the program. Furthermore, the CPU 710 secures a storage area corresponding to each of the storage units described above in the main storage device 720 according to the program. The communication of each device with other devices is executed as a result of the interface 740 having a communication function and performing communication according to the control of the CPU 710. The auxiliary storage device 730 is a non-transitory recording medium such as a CD (Compact Disc) or a DVD (digital versatile disc).

When the inference device 100 is implemented by the computer 700, the operation of the control unit 190 is stored in the auxiliary storage device 730 in the form of a program. The CPU 710 reads the program from the auxiliary storage device 730, expands the program in the main storage device 720, and executes the processing described above according to the program.

Furthermore, the CPU 710 secures a storage area corresponding to the storage unit 180 in the main storage device 720 according to the program. The communication performed by the communication unit 110 is executed as a result of the interface 740 having a communication function and performing communication according to the control of the CPU 710. The functions of the display unit 120 are executed as a result of the interface 740 having a display device, and images being displayed on the display screen of the display device according to the control of the CPU 710. The functions of the operation input unit 130 are performed as a result of the interface 740 having an input device and accepting user inputs, and outputting signals that indicate the accepted user inputs to the CPU 710.

When the inference device 300 is implemented by the computer 700, the operation of the inference unit 301 is stored in the auxiliary storage device 730 in the form of a program. The CPU 710 reads the program from the auxiliary storage device 730, expands the program in the main storage device 720, and executes the processing described above according to the program.

Furthermore, a program for executing some or all of the processing performed by the control unit 190 may be recorded in a computer-readable recording medium, and the processing of each unit may be performed by a computer system reading and executing the program recorded on the recording medium. The “computer system” referred to here is assumed to include an OS (Operating System) and hardware such as peripheral devices.

Furthermore, the “computer-readable recording medium” refers to a portable medium such as a flexible disk, a magnetic optical disk, a ROM (Read Only Memory), or a CD-ROM (Compact Disc Read Only Memory), or a storage device such as a hard disk built into the computer system. Moreover, the program may be one capable of realizing some of the functions described above. In addition, the functions described above may be realized in combination with a program already recorded in the computer system.

The present invention has been described above with reference to example embodiments (and examples). However, the present invention is not limited to the example embodiments (and examples) above. Various changes to the configuration and details of the present invention that can be understood by those skilled in the art can be made within the scope of the present invention.

This application is based upon and claims the benefit of priority from Japanese patent application No. 2019-064976, filed Mar. 28, 2019, the disclosure of which is incorporated herein in its entirety by reference.

### INDUSTRIAL APPLICABILITY

The present invention may be applied to an inference device, an inference method, and a recording medium.

### REFERENCE SYMBOLS

100, 300 Inference device
110 Communication unit (communication means)
120 Display unit (display means)
130 Operation input unit (operation input means)
180 Storage unit (storage means)
190 Control unit (control means)
191, 301 Inference unit (inference means)

1. An inference device comprising:
at least one memory configured to store instructions; and
at least one processor configured to execute the instructions to:
perform a qualitative inference using an inference rule which, from an input of a value indicating an increase and a value indicating a decrease, derives an output representing any one of an increase, a decrease, or no change.

2. The inference device according to claim 1, wherein the at least one processor is configured to execute the instructions to: perform a qualitative inference by switching between using the inference rule, and using an inference rule that derives an indefinite value.

3. An inference method comprising:
performing a qualitative inference using an inference rule which, from an input of a value indicating an increase and a value indicating a decrease, derives an output representing any one of an increase, a decrease, or no change.

4. A non-transitory recording medium that stores a program for causing a computer to execute:
performing a qualitative inference using an inference rule which, from an input of a value indicating an increase and a value indicating a decrease, derives an output representing any one of an increase, a decrease, or no change.
